(19) United States
(12) Patent Application Publication
(10) Pub. No.: US 2014/0170631 A1
(43) Pub. Date: Jun. 19, 2014

(54) ELECTRONIC WORD WALL SYSTEM

(71) Applicant: Donald G. Willis, Twinsburg, OH (US)

(72) Inventor: Donald G. Willis, Twinsburg, OH (US)

(21) Appl. No.: 13/714,794

(22) Filed: Dec. 14, 2012

(51) Int. Cl. G09B 5/00

(52) U.S. Cl. CPC G09B 5/00
USPC 434/365

(57) ABSTRACT

An electronic word wall system and a method for displaying information such as vocabulary words with an electronic word wall. The electronic word wall system includes an electronic word wall for displaying the information. Further, it includes an interactive control to upload the information to the electronic word wall. Finally, it includes at least one student interactive control device to interact with the information on the electronic word wall and generate data corresponding to the interaction.

### TECHNICAL FIELD OF THE INVENTION

The present invention relates generally to an electronic word wall system for displaying information such as vocabulary words. More specifically, the present invention relates to an electronic word wall for displaying the information, an interactive control to upload the information to the electronic word wall, and at least one student interactive control device to interact with the information.

### BACKGROUND OF THE INVENTION

A wide variety of visual message display devices such as bulletin boards, cork boards, erasable marking boards and felt boards have been produced. Such devices are typically designed to communicate by a single visual means. Educational display boards in current use generally exist as non-interactive pictorials hanging on classroom walls. These display boards are thin, inexpensive cardboard or plastic sheets imprinted with graphics and text depicting relational information.

Understanding and retaining vocabulary is vital to learning new subject matter. Therefore, teachers are always searching for improved ways to teach vocabulary so that students can understand the words' meanings when they are taught, apply the words in their proper context, and retain the words for future use. Further, retention in one subject area fosters conceptual associations and vocabulary building across all areas in which the method is employed. One device that has been used is a word wall display constructed of a blackboard or poster board on which an organized collection of words are prominently displayed in a classroom. This display is used as an interactive tool for teaching reading and spelling to children. Word walls have many benefits. They teach children to recognize and spell high frequency words, see patterns and relationship in words build phonemic awareness skills and apply phonics rules. Word walls also provide reference support for children during reading and writing activities. Children learn to be independent as they use the word walls in daily activities.

### SUMMARY OF THE INVENTION

According to an embodiment of the present invention, there is disclosed an electronic word wall system for displaying information such as vocabulary words. The electronic word wall system includes an electronic word wall for displaying the information. Further, it includes an interactive control to upload the information to the electronic word wall. Finally, it includes at least one student interactive control device to interact with the information on the electronic word wall and generate data corresponding to the interaction.

According to another embodiment of the present invention, a method is disclosed for displaying information such as vocabulary words with an electronic word wall system. The method includes uploading the information to the electronic word wall. The method further includes displaying the information on an electronic visual display of the electronic word wall. The method further includes interacting with the information on the electronic word wall with at least one student interactive control device and generating data corresponding to the interaction. Finally, the method includes analyzing the data and uploading adjusted information to the electronic word wall.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

FIG. 1 is a front view of electronic word wall system, in accordance with the present invention.

FIG. 2 is a front three dimensional view of the electronic word wall, in accordance with the present invention.

FIG. 3 is a flow chart of the steps required for using a first embodiment of the electronic word wall system, in accordance with the present invention.

FIG. 4 is a flow chart of the steps required for using a second embodiment of the electronic word wall system, in accordance with the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader, and should not in any way be interpreted as limiting.

A word wall is an organized collection of words prominently displayed in a classroom. This display is used as an interactive tool for teaching reading and spelling to children. Often, a great deal of a teacher's time is consumed by manually writing class words for a weekly or daily word wall.

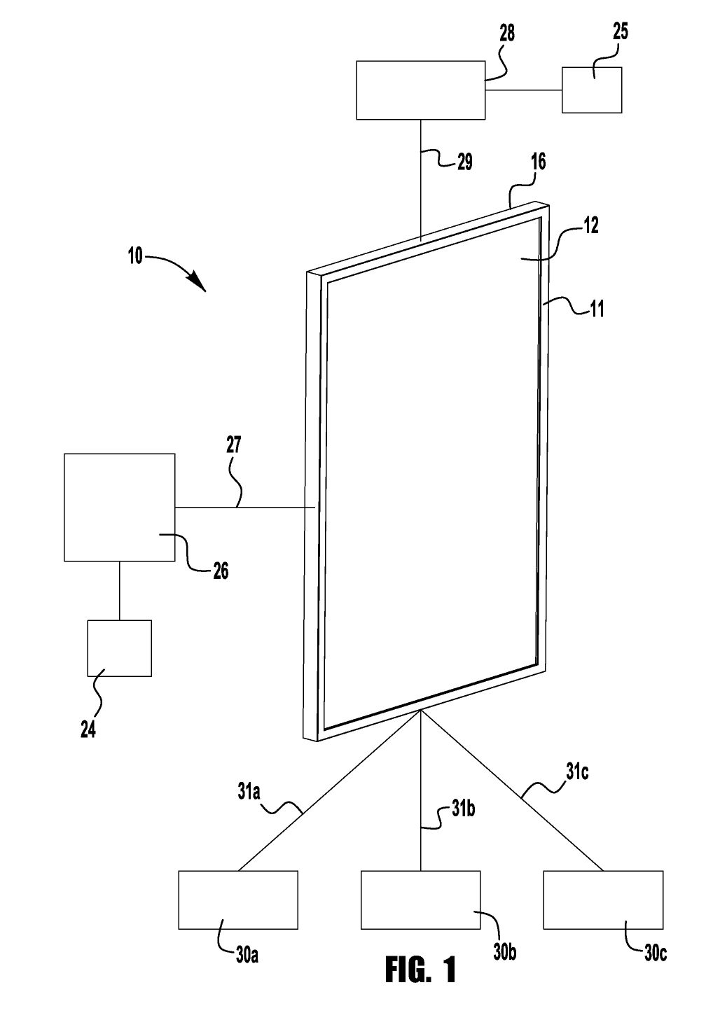

As shown in FIG. 1, an electronic word wall system 10 functions to electronically display vocabulary words in a school, or classroom environment. One aspect of the electronic word wall system 10 is meant to eliminate the need for a teacher having to manually construct a word wall, such as on a blackboard or poster board, on a daily or weekly basis. The electronic word wall system 10 will also have the ability to display the standard meanings and usages of words as well as the objectives being taught. Further, the electronic word wall system 10 can be connected to and operated by a central organization such as the school district or the school principal's office. This permits the school administrators to better focus and improve their efforts in increasing student's literacy and Standardized Test passage rates by allowing them the flexibility to uniformly disseminate and standardize the distribution of district/school vocabulary for all the grades within the school system.

FIG. 1 illustrates a front, three-dimensional view of the electronic word wall system 10. Electronic word wall system 10 includes an electronic word wall 11, a teacher interactive control 26, a school administration interactive control 28, and a plurality of student interactive control devices 30a, 30b, 30c (30a-30c).

Electronic word wall 11 includes an electronic visual display 12, a microprocessor (not shown) and other related hardware (not shown) that allow the software of word wall system 10 to function.

Electronic visual displays are pervasive in modern society for displaying information and entertainment content in consumer electronic products. For example televisions, laptop and desk top computer monitors, portable DVD players, and photo or image display devices. Generally these displays utilize liquid crystal or plasma technology.

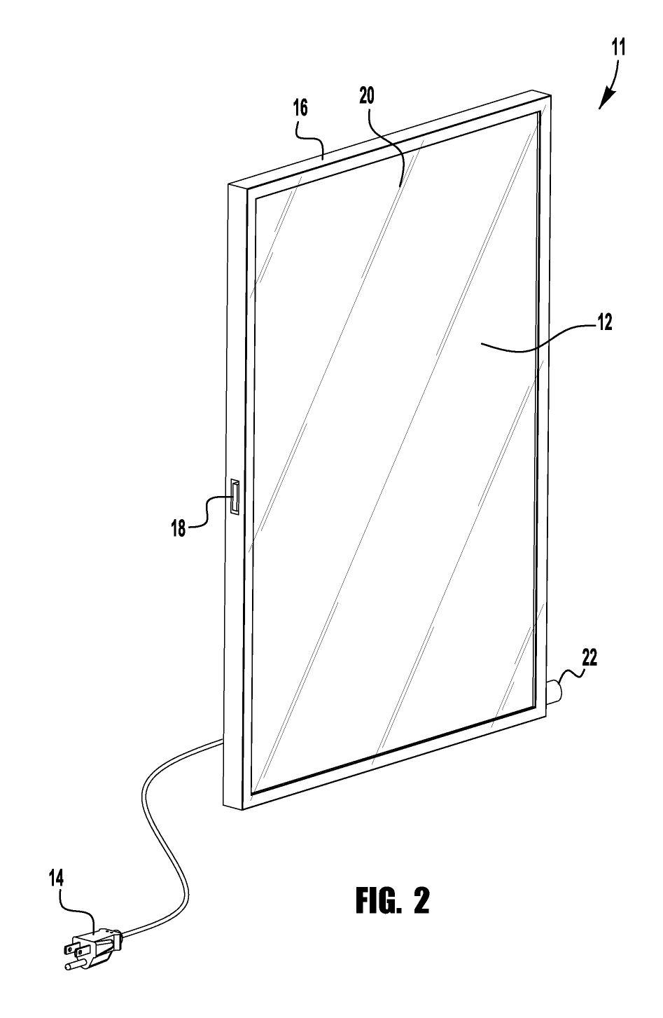

As illustrated in FIG. 2, electronic word wall 11 may utilize any suitable form of electronic visual display 12, typically a flat panel display. This may include but is not limited to a liquid crystal display (LCD), a light-emitting diodes display (LED), or plasma display panel (PDP). For example, an LCD includes a plurality of layers, most basically, a top glass, a liquid crystal, and a bottom glass. The top and bottom glass can be patterned to provide the boundaries of the cells that contain the liquid crystal for a particular display pixel. The top and bottom glass can also be patterned with various layers of conducting materials and thin film transistors that allow the voltage across the liquid crystal cells to be varied to manipulate the orientation of the liquid crystal, thereby controlling the color and brightness of the pixel. It is within the terms of the preferred embodiment that the electronic visual display 12 be a touch screen. Electronic visual display 12 may be powered with electronic cord 14, or with batteries (not shown).

As seen in FIG. 2, the word wall 11 includes the electronic visual display 12 which is located within a housing 16. The housing 16 may include an additional protective screen 20 to provide protection for the electronic visual display 12. There may be a locking element 22 to secure the housing 16 to prevent theft of the word wall 11. The dimensions of the word wall 11 may be any appropriate size, such as for example 3 feet×4 feet. The word wall 11 may be a freestanding device, or have means with which to hang it on a wall in a classroom. The words to be displayed on electronic visual display 12 can be inputted via a USB port 18 or sent electronically to the word wall 11 from the teacher interactive control 26 or the school administration interactive control 28.

The electronic word wall 11 is typically securely displayed in a learning environment, such as a school classroom, school hallway, or cafeteria. Electronic word wall 11 will have the ability to be removably secured to a wall, a stand or any other suitable mounting devices. Typically, word wall 11 will be elevated to an appropriate height to allow maximum vieweability. Further, it is within the terms of the embodiment that word wall 11 be mounted, such that it may swivel. Word wall 11 may have a locking element 22 to secure the word wall 11 to the wall or stand so as to deter against theft.

Referring again to FIG. 1, teacher interactive control 26 provides means for the class teacher to select the vocabulary words or other information to be displayed on the electronic word wall 11. This may be accomplished in a variety of ways. For example, a USB flash drive that contains the desired vocabulary words can be connected through USB port 18 and uploaded to be displayed upon the electronic visual display 12. Alternatively, the vocabulary words to be displayed may be sent electronically through line 27 to the word wall 11 from a computer at control 26. Using any of the uploading methods, the classroom teacher will have the ability to upload the daily, or weekly classroom objectives onto the word wall. It can be appreciated that because the teacher no longer would have the responsibility of handcrafting a traditional word wall, such as a black board or poster board, on a weekly or monthly basis, he or she would have additional time for other teaching duties.

After the students interact with the word wall 11, such as to complete exercises relating to vocabulary building, the teacher may examine their results. The teacher interactive control 26 may include a monitor 24 and a printer (not shown) to examine the results. In the case of vocabulary word skills, these results are examined for progress, and to ensure that the students are meeting the necessary levels of vocabulary achievement. Studies have shown that the more words a student knows and understands, the better his or her life outcome will likely be. The teacher may selectively choose words and exercises based on the results and progress shown by the students. For example, if a particular student is having trouble with certain words, the teacher will see these results and tailor exercises to the student's needs.

Referring again to FIG. 1, the school administration interactive control 28 allows school administrators, such as district, state and local school administrators, to select the vocabulary words or other information to be displayed on the electronic word wall 11. This may be accomplished in a variety of ways. For example, the school administrators can provide a USB flash drive that contains the desired vocabulary words and exercises to the teacher who in turn can connect the USB flash drive into the USB port 18 and upload the content for display upon visual display 12 of word wall 11. Alternatively, the vocabulary words or other information to be displayed on the electronic word wall 11 may be sent electronically to the word wall 11 through line 29 from a computer at school administration interactive control 28. This would allow for a commonality of vocabulary words to be viewed by all of the students in a particular grade, in a particular school district or region of the country.

Referring again to FIG. 1, the students may interact with the word wall 11 in a number of ways utilizing a plurality of student interactive control devices 30a, 30b, and 30c. While three interactive control devices 30a - 30c are shown, it is within the terms of the preferred embodiment to use any number of control devices and to use them in any combination, as described hereinafter.

For example, control device 30a can be a remote control that the students have to allow them to interact with the vocabulary words on the word wall 11. The remote control 30a can interconnect with the word wall 11 through a wire 31a or by a wireless connection. The remote control 30a allows interaction with the word wall 11 without teacher supervision. For example, the interaction may include matching a vocabulary word with its correct definition, or its synonym or antonym. Each student may log in with a username to the word wall 11 so that the results of his or her interaction with the word wall may be analyzed and stored so that later an individualized display of words and exercises can be provided.

Another possible control device 30b can be a computer or tablet which interconnects to the word wall 11 through a wire 31b or by a wireless connection. As with the control device 30a, the control device 30b allows students to interact with the vocabulary words or other information displayed on the electronic word wall 11 while seated at their desks. The remote control 30a allows interaction with the word wall 11 without teacher supervision. For example, the interaction may include matching a vocabulary word with its correct definition, or its synonym or antonym. Each student may log in with a username to the word wall 11 so that the results of his or her interaction with the word wall may be analyzed and stored so that later an individualized display of words and exercises can be provided.

Alternatively, a software program associated with the word wall 11 could send an identical vocabulary word problem to each student at his or her own computer. In this case, the students could complete the problem set either in the classroom or at home and the results analyzed and stored so that later an individualized display of words and exercises can be provided. Moreover, based on the results for each student, individualized assignments could be created, sent to the students and returned to the teacher or administrators by any means such as email.

Still another possible control device 30c, gives the students the opportunity to interface directly with the electronic visual display 12 of the word wall 11. In this case, the electronic visual display 12 is a touch screen, and the student may directly interact with the word wall 11 to manipulate the vocabulary words or other information displayed on the visual display 12 with his or her hand, or stylus. Each student may log in with a username to the word wall 11 so that the results of his or her interaction with the word wall may be stored and individualized.

The data results of the word wall system 10 from control device 30a-30c, including the remote control 30a, the computer or tablet control 30b, or direct physical control 30c through physically touching the word wall 11, can be stored and analyzed in the word wall 11 and/or at the teacher interactive control 26 and/or at the school administration interactive control 28. This information may be also stored and saved in a different location, such as a cloud storage system or a centralized storage location. As discussed earlier, the class teacher, and school administrators can access these data results, and manipulate the words on word wall system 10 accordingly.

The class teacher, school administrators, such as district, state and local school administrators, or any other suitable parties would have access to the results of the students interactions with the word wall 11, such as with the vocabulary words. The school administration interactive control 28 may include a monitor 25 and a printer (not shown) to examine the results. These results could be checked for every assignment, and weekly or monthly progress reports reported.

After the students interact with the word wall system 10, their data results may be examined by the teacher or school administrator. These results are examined for progress, and to ensure that the students are meeting the necessary levels of vocabulary achievement. Typically, the school administrators will focus on the overall progression of the students in a given grade, as opposed to individual student progress. The school administrators have the ability to adjust the software of the word wall system 10 in relationship to these data results. For example, if they notice a trend of students having trouble with a certain group of words, the word wall system 10 can be tailored to address these issues with the entire grade or school district.

The interaction between the students and word wall system 10 may be designed by the class teacher, school administrators, such as district, state and local school administrators, or any other suitable parties. The interactivity may be designed specifically for a particular class, or an entire school district or geographic region and may employ the same interactive devices to gauge how the students in a particular school are progressing. In order to provide a more enjoyable learning experience, games and simulated cartoons may be utilized on the word wall 11.

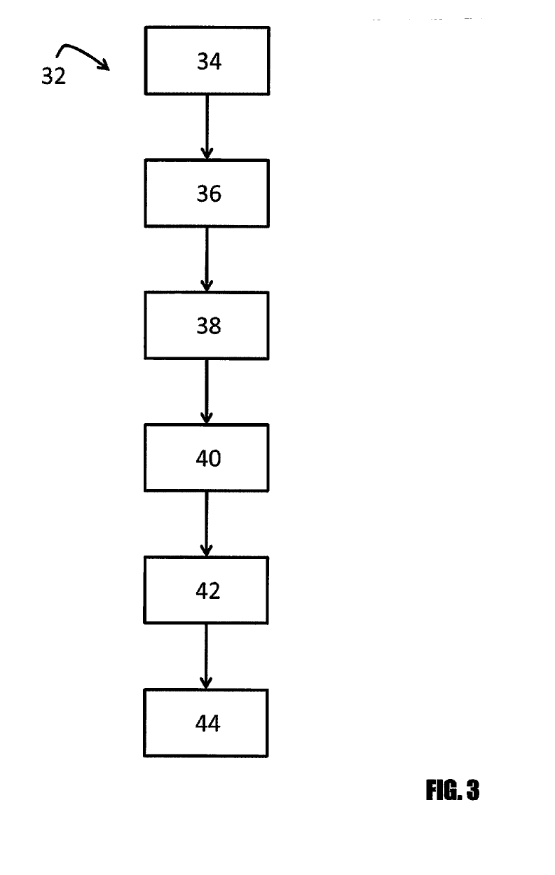

FIG. 3 illustrates a flow chart 32 of a first embodiment of the steps required for use of the electronic word wall system 10. In step 34, the teacher interactive control 26 uploads the information such as vocabulary words into the word wall 11, either electronically or through a USB flash drive that contains the desired vocabulary words or vocabulary exercises directly onto the word wall.

Next, in step 36, the information, such as vocabulary words, that has been uploaded by the teacher interactive control 26 is displayed on the word wall 11.

In Step 38, the students interact with the information on the electronic word wall 11 with at least one student interactive control device 30a-30c. The student interactive control device could be a remote control 30a, a computer or tablet 30b, or through control device 30c by physically touching the word wall 11. For control device 30c, the electronic visual display 12 is a touch screen. It is within the terms of the preferred embodiment to use any number of control devices and to use them in any combination.

Next, in step 40, data is generated corresponding to the interaction between the students and the word wall 11 of step 38.

In step 42, the teacher interactive control 26 receives the data generated by the student interactive control device 30a-30c that interacted with the information on the electronic word wall 11, and this data is displayed on a monitor 24. It is also within the terms of the preferred embodiment that there be a printer used by the teacher interactive control 26.

Next, in step 44, the teacher interactive control 26 analyzes the data and uploads adjusted information to the electronic word wall 11.

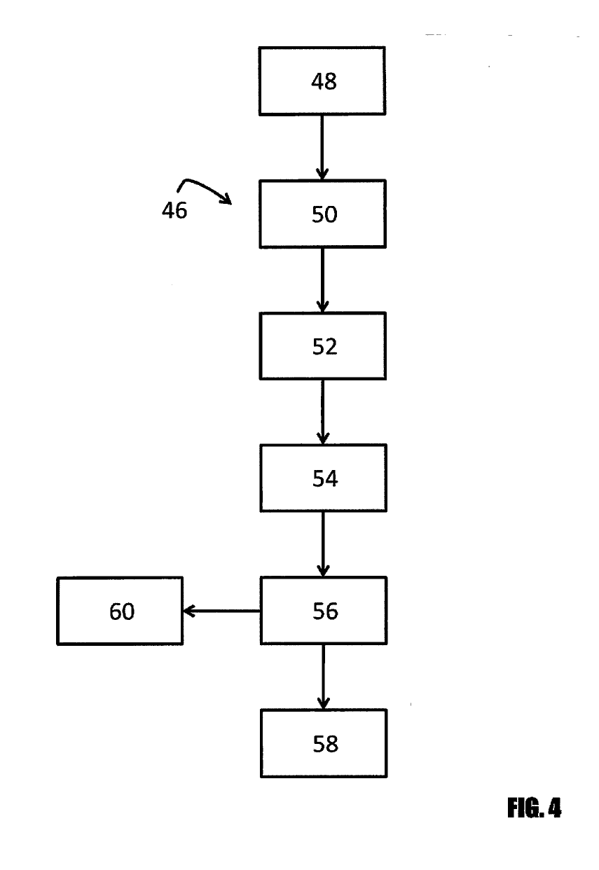

FIG. 4 illustrates a flow chart 46 of a second embodiment of the steps required for use of the electronic word wall system 10. In step 48, the school administration interactive control 28 uploads the information such as vocabulary words into the word wall 11, either electronically or through a USB flash drive that contains the desired vocabulary words or vocabulary exercises directly onto the word wall.

Next, in step 50, the information, such as vocabulary words, that has been uploaded by the school administration interactive control 28 is displayed on the word wall 11.

In Step 52, the students interact with the information on the electronic word wall 11 with at least one student interactive control device 30a-30c. The student interactive control device could be a remote control 30a, a computer or tablet 30b, or through control device 30c by physically touching the word wall 11. For control device 30c, the electronic visual display 12 is a touch screen. It is within the terms of the preferred embodiment to use any number of control devices and to use them in any combination.

Next, in step 54, data is generated corresponding to the interaction between the students and the word wall 11 of step 52.

In step 56, the school administration interactive control 28 receives the data generated by the student interactive control device 30a-30c that interacted with the information on the electronic word wall 11, and this data is displayed on a monitor 25. It is also within the terms of the preferred embodiment that there be a printer used by the school administration interactive control 28.

Next, in step 58, the school administration interactive control 28 analyzes the data and uploads adjusted information to the electronic word wall 11.

Alternatively, after step 56, the school administration interactive control 28 sends the data to the teacher interactive control 26 in step 60. Then, the teacher interactive control 26 analyzes the data and uploads adjusted information to the electronic word wall 11.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. An electronic word wall system for displaying information such as vocabulary words, comprising;
an electronic word wall for displaying the information;
an interactive control to upload the information to the electronic word wall; and
at least one student interactive control device to interact with the information on the electronic word wall and generate data corresponding to the interaction.

2. The electronic word wall system of claim 1 wherein the electronic word wall includes an electronic visual display.

3. The electronic word wall system of claim 2 wherein the electronic visual display is a touch screen.

4. The electronic word wall system of claim 1 wherein the interactive control is a school administration interactive control to upload the information to the electronic word wall and receive the data generated by the interaction.

5. The electronic word wall system of claim 4 wherein the data corresponding to the interaction is analyzed by the school administration interactive control so as to adjust the information uploaded to the electronic word wall.

6. The electronic word wall system of claim 5 wherein the school administration interactive control includes a monitor on which the data generated by the student is displayed.

7. The electronic word wall system of claim 1 wherein the interactive control is a teacher interactive control to upload the information to the electronic word wall and receive the data generated by the interaction.

8. The electronic word wall system of claim 7 wherein the data corresponding to the interaction is analyzed by the teacher interactive control so as to adjust the information uploaded to the electronic word wall.

9. The electronic word wall system of claim 8 wherein the teacher interactive control includes a monitor on which the data generated by the student is displayed.

10. The electronic word wall system of claim 1 wherein the at least one student interactive control device is a remote control.

11. The electronic word wall system of claim 1 wherein the at least one student interactive control device is a computer.

12. The electronic word wall system of claim 1 wherein the at least one student interactive control device is means for physically controlling the electronic word wall directly by touching the word wall.

13. A method for displaying information such as vocabulary words with an electronic word wall system, comprising;
uploading the information to the electronic word wall; and
displaying the information on an electronic visual display of the electronic word wall;
interacting with the information on the electronic word wall with at least one student interactive control device and generating data corresponding to the interaction; and
analyzing the data and uploading adjusted information to the electronic word wall.

14. The method of claim 13 including uploading the information to the electronic word wall with a teacher interactive control and receiving the data generated by the at least one student interactive control device interacting with the information on the electronic word wall.

15. The method of claim 14 including uploading the information to the electronic word wall with a school administration interactive control and receiving the data generated by the at least one student interactive control device interacting with the information on the electronic word wall.

16. The method of claim 15 including displaying on a monitor the data generated by the at least one student interactive control device interacting with the information on the electronic word wall.

17. The method of claim 14 including interacting with the information on the electronic word wall with a remote control.

18. The method of claim 14 including interacting with the information on the electronic word wall with a computer.

19. The method of claim 14 including providing a touch screen electronic visual display.

20. The method of claim 18 including interacting with the information on the electronic word wall by touching the touch screen electronic visual display.
